(19) United States
(12) Patent Application Publication
(10) Pub. No.: US 2025/0150917 A1
(43) Pub. Date: May 8, 2025

(54) ELECTRONIC DEVICE, METHOD, AND STORAGE MEDIUM STORING PROGRAM

(71) Applicant: CANON KABUSHIKI KAISHA, Tokyo (JP)

(72) Inventor: KOJI OKAMURA, Kanagawa (JP)

(21) Appl. No.: 18/939,718

(22) Filed: Nov. 7, 2024

(30) Foreign Application Priority Data
Nov. 8, 2023 (JP) 2023-191128

(51) Int. Cl. H04W 36/08; H04W 76/14

(52) U.S. Cl. CPC H04W 36/08; H04W 76/14

(57) ABSTRACT

An electronic device that can communicate with an external access point, includes: a first change unit that changes, on a basis of reception of the first change request, a connection destination of the electronic device to a second access point included in one or more access points corresponding to information included in a first change request, and a second change unit that changes, on a basis of a predetermined amount of time elapsing since the connection destination of the electronic device has changed to the second access point on a basis of reception of the first change request, the connection destination of the electronic device to the first access point without reception of a second change request to request change of the connection destination of the electronic device from the second access point.

### BACKGROUND OF THE INVENTION

### Field of the Invention

The present invention relates to an electronic device that can connect via a wireless LAN, a method, and a storage medium storing a program.

### Description of the Related Art

In the field of extended service sets (ESS) configured of a plurality of access points (AP), a known technology dynamically switches connection destination APs for efficient data exchange between the APs and a station (STA). When it is determined to switch the connection destination AP on the basis of the congestion of the AP the STA is connected to, the availability of other APs, the radio wave situation, and the like, the currently connected AP transmits a change connected AP request to the STA. When the STA receives the change AP request, the STA can connect to an appropriate AP by switching the connection destination AP in accordance with the request.

Japanese Patent Laid-Open No. 2021-175068 describes the following as processing for requesting a change in the connection destination from a router provided with an AP function to a currently connected wireless client. A mobile router (MR1) that can connect to a plurality of wireless clients checks whether a wireless client terminal supports IEEE 802.11v. Whether the wireless client terminal supports IEEE 802.11v is determined from an association request frame that is transmitted when the wireless client terminal wirelessly connects to the MR1. If the wireless client terminal supports IEEE 802.11v, a BSS transition management (BTM) request frame is transmitted to the corresponding wireless client terminal. A BSS transition candidate list entries field of the BTM request designates the BSSID of a master unit router RT2 as the connection destination. This prompts the connection destination of the client terminal to be switched, and the wireless client terminal switches the connection destination from the MR1 to the RT2 in accordance with the received BTM request.

### SUMMARY OF THE INVENTION

The present invention provides an electronic device that enables control to the change of the connection destination AP in a case where the connection destination changes from an access point determined via user setting to another access point, a method, and a storage medium storing a program.

The present invention in one aspect provides an electronic device that can communicate with an external access point, comprising: at least one processor and at least a memory coupled to the at least one processor and having instructions stored thereon, and when executed by the at least one processor, acting as: a connection unit configured to establish a connection between a first access point and the electronic device, a first reception unit configured to receive, from the first access point, a first change request to request change of a connection destination of the electronic device, a first change unit configured to change, on a basis of reception of the first change request, the connection destination of the electronic device to a second access point included in one or more access points corresponding to information included in the first change request, and a second change unit configured to change, on a basis of a predetermined amount of time elapsing since the connection destination of the electronic device has changed to the second access point on a basis of reception of the first change request, the connection destination of the electronic device to the first access point without reception of a second change request to request change of the connection destination of the electronic device from the second access point.

According to the present disclosure, changing the connection destination AP can be controlled in a case where the connection destination changes from an access point determined by user setting to another access point.

Further features of the present invention will become apparent from the following description of exemplary embodiments with reference to the attached drawings.

### BRIEF DESCRIPTION OF THE DRAWINGS

FIG. 1 is a diagram illustrating a system configuration.

FIGS. 2A and 2B are diagrams illustrating the configuration of an MFP.

FIGS. 3A to 3C are diagrams illustrating an operation display unit of an MFP.

FIGS. 4A and 4B are diagrams illustrating the configuration of a mobile terminal apparatus.

FIG. 5 is a diagram illustrating the configuration of an access point.

FIG. 6 is a sequence diagram for describing the processing executed in response to a connection destination change request from an AP.

FIG. 7 is a flowchart illustrating the processing in the MFP.

FIG. 8 is a flowchart illustrating the processing in the MFP.

FIG. 9 is a flowchart illustrating the processing in the MFP.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

After an STA connects to an AP determined by user setting, if a change connection destination AP request is received from that AP, the connection destination is automatically switched to another AP. In this case, if no further change connection destination AP requests are received, the STA remains connected to the AP that is not the AP determined by user setting.

According to the present disclosure, changing the connection destination AP can be controlled in a case where the connection destination changes from an access point determined by user setting to another access point.

### First Embodiment

### System Configuration

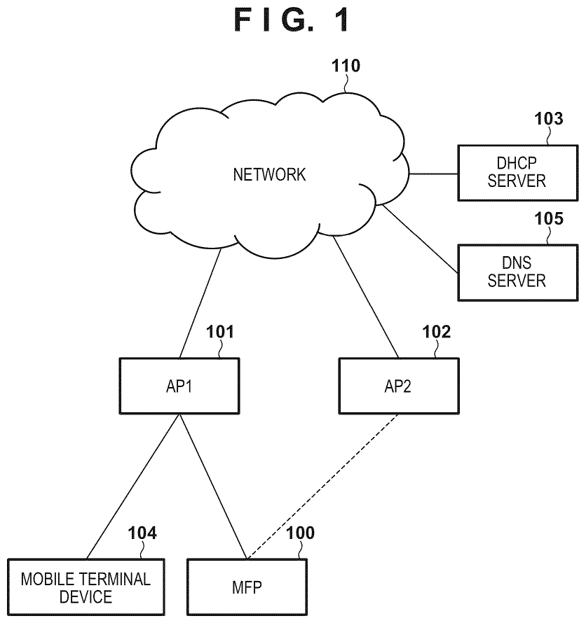

FIG. 1 is a diagram illustrating an example configuration of a system according to the present embodiment. The present system, in this example, is a wireless communication system enabling wireless communication between a plurality of communication apparatuses. In the example of FIG. 1, the communication apparatus include a mobile terminal apparatus 104, an MFP 100, access points AP 101 and AP 102, a DHCP server 103, a DNS server 105, and a network 110. Note that in the drawings, the AP 101 may be displayed as AP1 and the AP 102 may be displayed as AP2. The mobile terminal apparatus 104 is an apparatus with a wireless communication function such as wireless LAN. Note that hereinafter, wireless LAN may be referred to as WLAN. The mobile terminal apparatus 104 may be a personal digital assistant (PDA) or similar personal information terminal, a mobile phone (smartphone), a digital camera, a personal computer, or the like.

The MFP 100 is a printing apparatus with a print function and may also have a read function (scanner), a fax function, and a phone function. Also, the MFP 100 according to the present embodiment has a communication function enabling wireless communication with the mobile terminal apparatus 104. Also, in the present embodiment described herein, the MFP 100 is used as an example, but no such limitation is intended. For example, instead of the MFP 100, a scanner apparatus, a projector, a mobile terminal, a smartphone, a note PC, a tablet terminal, a PDA, a digital camera, a music playback device, a television, a smart speaker, or the like with a communication function may be used. Note that MFP is an acronym for multifunction peripheral.

The AP 101 operates as a WLAN base station apparatus provided separate to (outside of) the mobile terminal apparatus 104 and the MFP 100. A communication apparatus with a WLAN communication function can communicate in WLAN infrastructure mode via the AP 101. Note that hereinafter, access point may be referred to as AP. Also, infrastructure mode may be referred to as wireless infrastructure mode. The AP 101 wirelessly communicates with a communication apparatus permitted (authenticated) to connect to it, and the communication apparatus relays wireless communication to other communication apparatuses. Also, the AP 101 may be connected to a wired communication network, for example, and relay communication between a communication apparatus connected to this wired communication network and other communication apparatuses wirelessly connected to the AP 101.

The AP 102 has similar functions to the AP 101, and the MFP 100 switches connection from the AP 101 to the AP 102 as necessary. The DHCP server 103 is connected to the MFP 100 via the AP 101 and the network 110 and provides a service to the MFP 100 by responding to a request from the MFP 100. Note that the DHCP server 103 in FIG. 1 is illustrated as being connected to the AP 101 and the AP 102 as a separated device. However, the AP 101 and the AP 102 may have a DHCP server function. The DNS server 105 is connected to the MFP 100 and the mobile terminal apparatus 104 via the AP 101 and the network 110 and provides a service for name resolution by responding to a request from the MFP 100 or the mobile terminal apparatus 104. Here, the network 110 may be the so-called Internet, but a closed internal company network or a cellular network may be used.

### MFP External Appearance

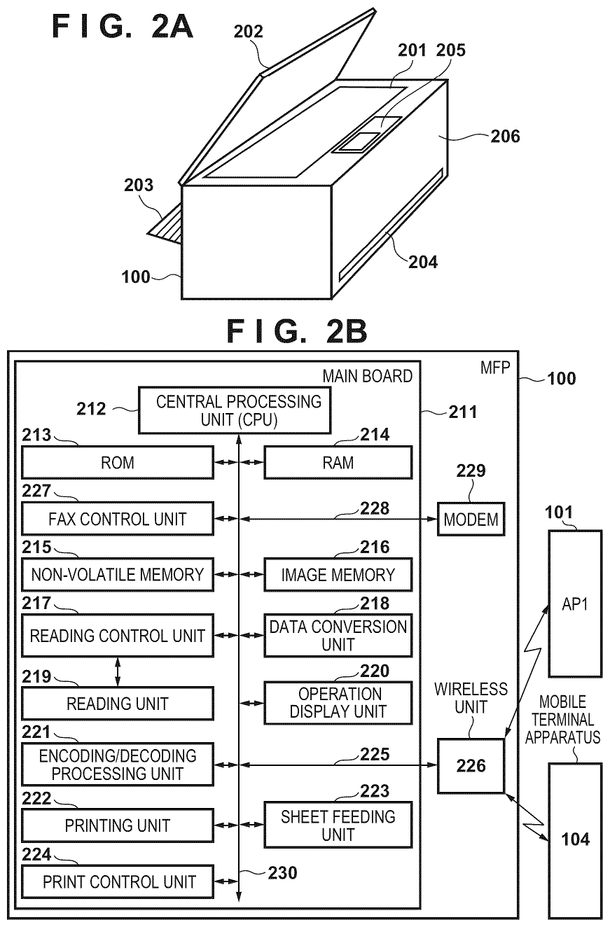

FIG. 2A illustrates an example of the external appearance of the MFP 100. The MFP 100 includes, for example, a platen 201, a document cover 202, a printing paper insertion opening 203, a printing paper discharge opening 204, and an operation display unit 205. The platen 201 is a platform for placing documents to be read. The document cover 202 is a cover used to press against a document placed on the platen 201 or prevent light from a light source illuminating the document escaping out during reading. The printing paper insertion opening 203 is an insertion opening where various sizes of sheets can be set. The printing paper discharge opening 204 is a discharge opening where sheets are discharged after printing. The sheets set in the printing paper insertion opening 203 are conveyed one sheet at a time to a printing unit and are discharged from the printing paper discharge opening 204 after printing has been performed by the printing unit. The operation display unit 205 includes character input keys, a cursor key, an enter key, a cancel key, and/or similar keys; LEDs; an LCD; and the like. The operation display unit 205 is configured to receive operations from the user relating to the activation of various types of functions of an MFP and various types of settings. Also, the operation display unit 205 may include a touch panel display. The MFP 100 has a WLAN wireless communication function and includes a wireless communication antenna 206 for wireless communication that is not necessarily visible from the outside. The MFP 100 can perform wireless communication via WLAN in a frequency range of the 2.4 GHz band or the 5 GHz band in a similar manner to the mobile terminal apparatus 104.

### MFP Configuration

FIG. 2B illustrates an example of the configuration of the MFP 100. The MFP 100 includes a mainboard 211 for performing main control of the apparatus itself and a wireless unit 226, which is a single communication module for performing WLAN communication using at least one shared antenna. Also, the MFP 100 includes a modem 229 for performing wired communication, for example. The mainboard 211 includes, for example, a CPU 212 (central processing unit), a ROM 213, a RAM 214, a non-volatile memory 215, an image memory 216, a reading control unit 217, a data conversion unit 218, a reading unit 219, and an encoding/decoding processing unit 221. Also, the mainboard 211 includes, for example, a printing unit 222, a sheet feeding unit 223, a print control unit 224, and an operation display unit 220. These functional units in the mainboard 211 are connected to one another via a system bus 230 managed by the CPU 212. Also, the mainboard 211 and the wireless unit 226 are connected via a dedicated bus 225, for example, and the mainboard 211 and the modem 229 are connected via a bus 228, for example.

The CPU 212 is a system control unit including at least one processor that controls the entire MFP 100. The processing of the MFP 100 described below is, for example, implemented by the CPU 212 executing programs stored in the ROM 213. Note that dedicated hardware may be prepared for each item of processing. ROM 213 stores control programs executed by the CPU 212, embedded OS programs, and the like. In the present embodiment, in a similar manner, the CPU 212 executes the control programs stored in the ROM 213 under the management of the embedded OS stored in the ROM 213 to perform software control such as scheduling and task switching.

The RAM 214 is constituted by an SRAM or the like. The RAM 214 stores data such as program control variables and the like, setting values registered by the user, MFP 100 management data, and the like. Also, the RAM 214 may be used as a buffer for various types of work. The non-volatile memory 215 is constituted by memory such as flash memory, for example, and continually stores data even after power to the MFP 100 is turned off. The image memory 216 is constituted by a memory such as a DRAM. The image memory 216 stores image data received via the wireless unit 226, image data processed by the encoding/decoding processing unit 221, and the like. Note that the memory configuration of the MFP 100 is not limited to the configuration described above. The data conversion unit 218 analyzes data of various formats, converts image data into print data, and the like.

The reading control unit 217 controls the reading unit 219 (for example, a contact image sensor (CIS)) to optically read the document placed on the platen 201. The reading control unit 217 converts the image obtained by optically reading the document into electrical image data (an image signal) for output. The reading control unit 217 may perform various types of processing such as binarization processing and halftone processing at this time and then output the image data.

The operation display unit 220 is the operation display unit 205 described with reference to FIG. 2A and displays to a display according to display control by the CPU 212 and generates signals in accordance with received user operations.

The encoding/decoding processing unit 221 performs encoding processing and decoding processing and enlargement and reduction processing of image data (JPEG, PNG, and the like) handled by the MFP 100. The sheet feeding unit 223 holds sheets for printing. The sheet feeding unit 223 can supply sheets that have been set under the control of the print control unit 224. The sheet feeding unit 223 may include a plurality of sheet feeding units for holding a plurality of types of sheets in one apparatus and can control which sheet feeding unit to feed from under the control of the print control unit 224.

The print control unit 224 executes various types of processing such as smoothing processing, print density correction processing, and color correction on the image data to be printed and outputs post-processing image data to the printing unit 222. The printing unit 222 is configured to execute an inkjet printing process by discharging ink supplied from ink tanks from a print head and printing an image on a printing medium such as a sheet. Note that the printing unit 222 may be configured to execute an electro-photographic or other printing process. Also, the print control unit 224 may periodically read out information of the printing unit 222 and update status information such as ink tank remaining amount, print head state, and the like stored in the RAM 214.

The wireless unit 226 is a unit that can provide a WLAN communication function and, for example, can provide a function similar to a combination with a WLAN unit 429 of the mobile terminal apparatus 104. In other words, the wireless unit 226, following a WLAN protocol, converts data into packets and transmits packets to other devices or restores packets from other external devices into the original data and outputs them to the CPU 212. The wireless unit 226 can communicate as a station compliant with the IEEE 802.11 standard series. In particular, communication is possible as a station compliant with IEEE 802.11a/b/g/n/ac/ax. Hereinafter, station may be referred to as STA. Also, communication is possible as a STA supporting Wi-Fi Agile Multiband (trademark).

The wireless unit 226 supports IEEE 802.11ax, that is, Wi-Fi 6 (trademark) and can execute processing compliant with IEEE 802.11ax. In other words, the MFP 100 can process as a STA supporting (compliant with) OFDMA and/or can operate (process) as a STA supporting (compliant with) TWT. OFDMA is an abbreviation for orthogonal frequency-division multiple access. TWT is an abbreviation for target wake time. As TWT is supported, the data communication timing from the master unit to the STA is adjusted. The wireless unit 226 (MFP 100), which is a STA, transitions the communication function to a sleep state when signal reception standby is not required. This can reduce power consumption. Also, the wireless unit 226 also supports Wi-Fi 6E (trademark). In other words, communication in the 6 GHz band (5.925 GHz to 7.125 GHz) can be performed. The target band for dynamic frequency selection (DFS) in the 5 GHz band is not in the 6 GHz band. Thus, with communication in the 6 GHz band, communication disconnections due to DFS standby time do not occur. Thus, better communication can be expected.

Note that the mobile terminal apparatus 104 and the MFP 100 can perform P2P (WLAN) communication based on WFD, and the wireless unit 226 has a software access point (software AP) function or a group owner function. In other words, the wireless unit 226 can configure a P2P communication network, determine a channel to use for P2P communication, and the like.

### MFP Operation Display Unit

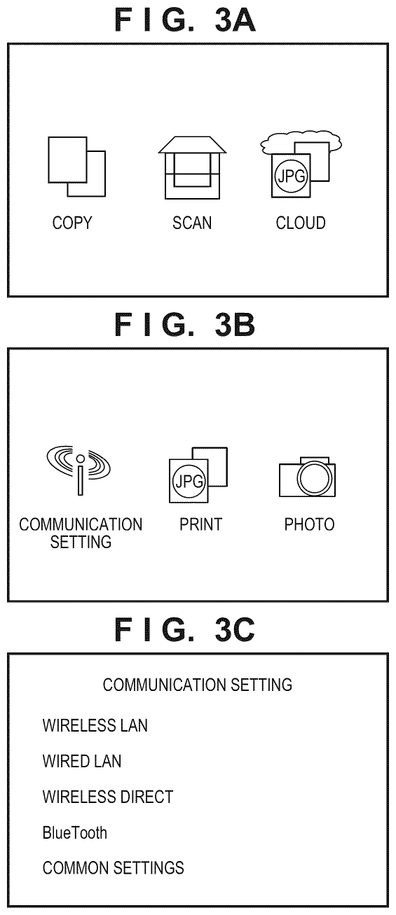

FIGS. 3A to 3C schematically illustrate example of a screen display on a display (touch panel display) including in the operation display unit 220 of the MFP 100. FIG. 3A is an example of a home screen displayed when the power of the MFP 100 is turned on and no operations such as printing or scanning are being performed (idle state, standby state). In FIG. 3A, display items (menu items) corresponding to copy, scan, and cloud are displayed. Cloud is a menu item relating to a cloud function using Internet communication. When one of the menu items is selected via operation of a key or the touch panel, the MFP 100 may start executing the corresponding setting or function. The MFP 100 can seamlessly display a screen different from that of FIG. 3A when a key or touch panel operation on the home screen of FIG. 3A is received.

FIG. 3B is an example of a display of another part of the home screen and is a screen transitioned to from the state of FIG. 3A via an operation (left or right slide operation or the like) to display another page of the home screen. In FIG. 3B, display items (menu items) corresponding to communication settings, print, and photo are displayed. When one of these menu items is selected, the function corresponding to the selected menu item, that is, the print function, the photo function, or the communication settings, is executed.

FIG. 3C is an example of a display of a menu screen for communication settings displayed when communication settings is selected on the screen of FIG. 3B. On the menu screen for communication settings, “Wireless LAN”, “Wired LAN”, “Wireless Direct”, “Bluetooth”, and “Shared Settings” are displayed as menu items (options). “Wireless LAN”, “Wired LAN”, and “Wireless Direct” are menu items for LAN settings, and from these items, wired connection settings, wireless infrastructure mode on/off settings, WFD, SoftAP mode, or similar P2P mode on/off settings, and the like can be set. When the “Wireless LAN” item is selected and wireless LAN is set to on by a user operation, the wireless infrastructure mode is turned on. When the “Wireless direct” item is selected and wireless direct is set to on by a user operation, the P2P (WLAN) mode is turned on. On this screen, a shared settings menu relating to each connection state is also displayed. Also, the user can set the wireless LAN frequency range and frequency channel and the like from this screen.

### Mobile Terminal Apparatus External Appearance

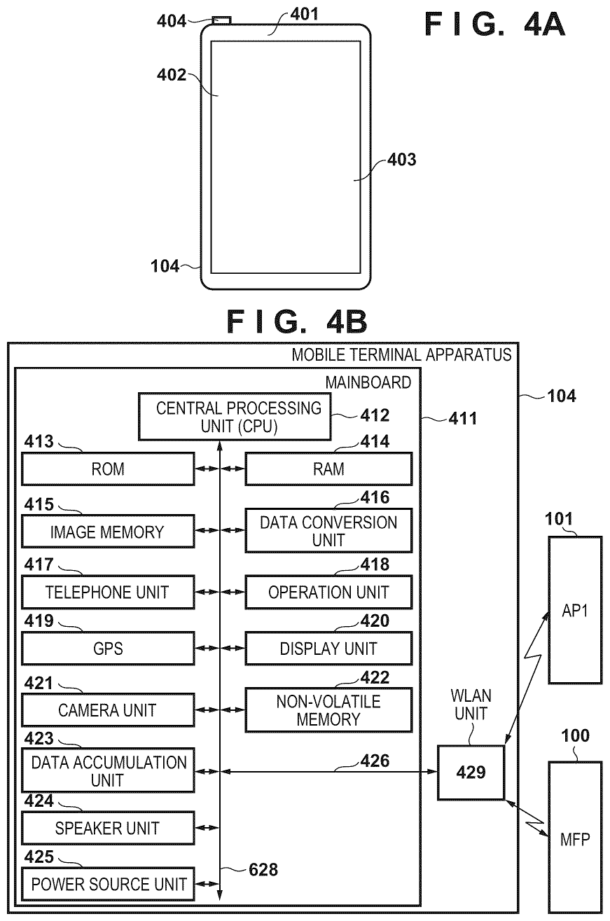

FIG. 4A is a diagram illustrating an example of the external appearance configuration of the mobile terminal apparatus 104. In the present embodiment, in this example, the mobile terminal apparatus 104 is a typical type of smartphone. Note that the mobile terminal apparatus 104, for example, includes a display portion 402, an operation portion 403, and a power key 404. The display portion 402 is a display including a liquid crystal display (LCD) display mechanism, for example. Note that the display portion 402 may display information using a light-emitting diode (LED), for example. Also, the mobile terminal apparatus 104 may have a function of outputting information via audio in addition to or instead of the display portion 402. The operation portion 403 includes physical keys such as keys and buttons, a touch panel, and the like for detecting a user operation. Note that in the present example, since displaying information on the display portion 402 and receiving user operation via the operation portion 403 is performed using a common touch panel display, the display portion 402 and the operation portion 403 is implemented using a single apparatus. In this case, for example, button icons and a software keyboard are displayed using a display function via the display portion 402, and the user touching these sections is detected by an operation reception function via the operation portion 403. Note that the display portion 402 and the operation portion 403 may be separated, and a piece of hardware for display and a piece of hardware for operation reception may be individually prepared. The power key 404 is a physical key for receiving a user operation for turning the power of the mobile terminal apparatus 104 on or off.

The mobile terminal apparatus 104 includes a WLAN unit 401 that provides a WLAN communication function and is not necessarily visible from the outside. The WLAN unit 401 is configured to execute data (packet) communication in a WLAN system compliant with the IEEE 802.11 standard series (IEEE 802.11a/b/g/n/ac/ax and the like), for example. Also, communication is possible as an AP supporting Wi-Fi Agile Multiband (trademark). However, no such limitation is intended, and the WLAN unit 401 may be configured to execute WLAN communication compliant with another standard. Note that in this example, the WLAN unit 401 can communicate on both a 2.4 GHz frequency band channel and a 5 GHz frequency band channel. Also, the WLAN unit 401 can execute communication based on WFD, communication using a SoftAP mode, communication using a wireless infrastructure mode, and the like. Operations in these modes will be described below.

### Mobile Terminal Apparatus Configuration

FIG. 4B illustrates an example of the configuration of the mobile terminal apparatus 104. The mobile terminal apparatus 104 in this example includes a mainboard 411 for executing main control of the apparatus itself and the WLAN unit 429 for WLAN communication. The mainboard 411 includes, for example, a CPU 412, a ROM 413, a RAM 414, an image memory 415, a data conversion unit 416, a telephone unit 417, a GPS 419, a camera unit 421, a non-volatile memory 422, a data accumulation unit 423, a speaker unit 424, and a power source unit 425. Here, CPU is an acronym for central processing unit, ROM is an acronym for read only memory, RAM is an acronym for random access memory, and GPS is an acronym for global positioning system. The mobile terminal apparatus 104 also includes a display unit 420 and an operation unit 418. Each functional unit in the mainboard 411 is connected to one another via a system bus 628 managed by the CPU 412. Also, the mainboard 411 and the WLAN unit 429 (the WLAN unit 401 described above) are connected via a dedicated bus 426, for example.

The CPU 412 is a system control unit including at least one processor that controls the entire mobile terminal apparatus 104. The processing of the mobile terminal apparatus 104 described below is, for example, implemented by the CPU 412 executing programs stored in the ROM 413. Note that dedicated hardware may be prepared for each item of processing. The ROM 413 stores a control program executed by the CPU 412, an embedded operating system (OS) program, and the like. In the present embodiment, in a similar manner, the CPU 412 executes the control programs stored in the ROM 413 under the management of the embedded OS stored in the ROM 413 to perform software control such as scheduling and task switching.

The RAM 414 is constituted by a Static RAM (SRAM) or the like. The RAM 414 stores data such as program control variables and the like, setting values registered by the user, mobile terminal apparatus 104 management data, and the like. Also, the RAM 414 may be used as a buffer for various types of work. The image memory 415 is constituted by a memory such as a Dynamic RAM (DRAM). The image memory 415 temporarily stores image data received via the WLAN unit 429 and image data read out from the data accumulation unit 423 for processing by the CPU 412. The non-volatile memory 422 is constituted by memory such as flash memory, for example, and continually stores data even after power to the mobile terminal apparatus 104 is turned off. Note that the memory configuration of the mobile terminal apparatus 104 is not limited to the configuration described above. For example, the image memory 415 and the RAM 414 may be shared, and data backup and the like may be performed using the data accumulation unit 423. Also, in the present embodiment, DRAM was given as an example of the image memory 415. However, another storage medium such as a hard disk or a non-volatile memory may be used.

The data conversion unit 416 executes analysis of data of various formats and data conversion, such as color conversion and image conversion. The telephone unit 417 performs control of a telephone line and implements telephone communication by processing audio data input/output via the speaker unit 424. The GPS 419 receives radio waves sent from satellites and obtains position information, for example the current latitude and longitude of the mobile terminal apparatus 104.

The camera unit 421 has a function of electronically recording and encoding an image input via a lens. The image data obtained via image capture by the camera unit 421 is stored in the data accumulation unit 423. The speaker unit 424 performs control to implement a function of inputting or outputting audio for the telephone function, as well as an alarm notification and the like. The power source unit 425 is a portable battery that controls power supply to the apparatus, for example. Power source states include, for example, a battery dead state in which the battery has no remaining amount, a power-off state in which the power key 404 is not pressed, an active state in which the apparatus is normally active, and a power saving state in which the apparatus is active but is set in a power saving mode.

The display unit 420 corresponds to the display portion 402 described with reference to FIG. 4A and displays various types of input operations, the operation situation of the mobile terminal apparatus 104, status situations, and the like on the basis of control by the CPU 412. The operation unit 418 corresponds to the operation portion 403 described with reference to FIG. 4A and performs control including generating an electrical signal corresponding to a received user operation and outputting the electrical signal to the CPU 412.

The mobile terminal apparatus 104 can perform wireless communication using the WLAN unit 429 and communicate data with another device such as the MFP 100. The WLAN unit 429 converts the data into packets and transmits the packets to the other device. Also, the WLAN unit 429 restores a packet from an external other device into the original data and outputs this to the CPU 412. The WLAN unit 429 is a unit for implementing communication compliant with the WLAN standards. The WLAN unit 429 can operate in at least two communication modes in parallel, the at least two communication modes including wireless infrastructure mode and P2P (WLAN) mode. Note that the frequency range used in these communication modes may be restricted by the functions and performance of the hardware.

### Access Point Configuration

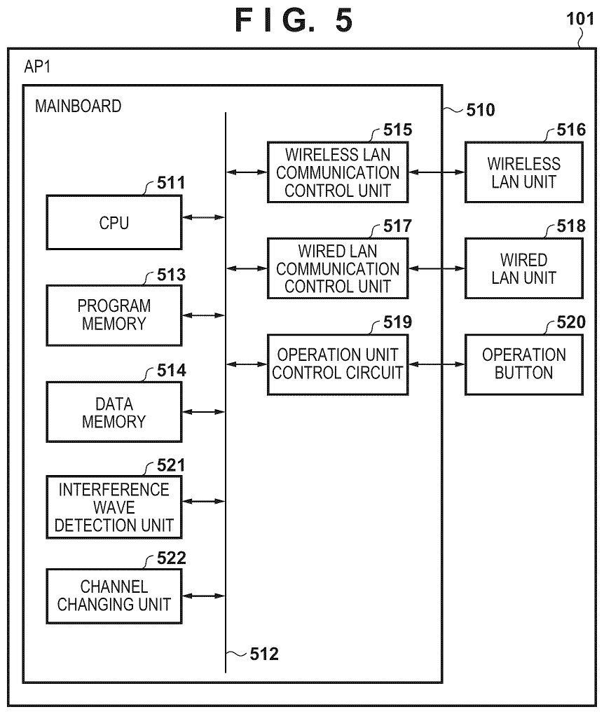

FIG. 5 is a block diagram illustrating the configuration of the AP 101 with a wireless LAN access point function. The AP 101 includes a mainboard 510 for performing control of the AP 101, a wireless LAN unit 516, a wired LAN unit 518, and an operation button 520.

A CPU 511 in the form of a microprocessor disposed on the mainboard 510 operates according to a control program stored in a program memory 513 in the form of ROM connected via an internal bus 512, data stored in a data memory 514 in the form of RAM, and the like. The CPU 511 performs wireless LAN communication with other communication terminal apparatuses by controlling the wireless LAN unit 516 via a wireless LAN communication control unit 515. Also, the CPU 511 performs wired LAN communication with other communication terminal apparatuses by controlling the wired LAN unit 518 via a wired LAN communication control unit 517. The CPU 511 can receive operations from the user via the operation button 520 by controlling an operation unit control circuit 519. The CPU 511 includes at least one processor.

Also, the AP 101 includes an interference wave detection unit 521 and a channel change unit 522. The interference wave detection unit 521 executes interference detection processing during wireless communication in a band where dynamic frequency selection is performed. The channel change unit 522 executes processing to change the channel to use when an interference wave is detected, when an empty channel needs to be immediately changed to, and the like during wireless communication in a band where DFS is performed.

Note that the AP 102 has a configuration similar to that of the AP 101.

### P2P Communication Method

Next, in WLAN communication, the P2P (WLAN) communication method for apparatuses to wirelessly communicate directly bypassing an external access point will be described. P2P (WLAN) communication can be implemented using a plurality of methods. For example, a communication apparatus can support a plurality of modes for P2P (WLAN) communication and can perform P2P (WLAN) communication selectively using one of the plurality of modes.

The following two modes are examples of P2P modes.
SoftAP mode
Wi-Fi Direct (WFD) mode.

The communication apparatus that can execute P2P communication may be configured to support at least one of the plurality of modes. On the other hand, a communication apparatus that can execute P2P communication does not mean that all of the modes are supported, and the communication apparatus may be configured to only support a portion of the modes.

With a communication apparatus (for example, the mobile terminal apparatus 104) having a communication function using WFD, when a user operation is received via the operation unit, an application (dedicated is some cases) for implementing the communication function is invoked. Then, the communication apparatus displays a user interface (UI) screen provided by the application and prompts for a user operation. WFD communication may be performed on the basis of the user operation received in response to this.

### SoftAP Mode

In SoftAP mode, the communication apparatus (for example, the mobile terminal apparatus 104) operates as a client that requests the various types of service. Another communication apparatus (for example, the MFP 100) operates as a soft AP that can execute a WLAN AP function set by the software. Note that it is sufficient that the commands and parameters transmitted and received when establishing a wireless connection between the client and the soft AP are as specified by Wi-Fi (registered trademark) standards, and thus description thereof will be omitted. Also, the MFP 100 that operates in the SoftAP mode determines the frequency band and the frequency channel as a master station. Thus, the MFP 100 can select which frequency range to use from among the 5 GHz frequency band and the 2.4 GHz frequency band and which frequency channel to use in the frequency band.

### WFD Mode

The MFP 100 may be configured to constantly active as a WFD mode master station (autonomous group owner). This make Go Negotiation processing for determining roles unnecessary. Also, in this case, the MFP 100 determines the frequency band and the frequency channel as a master station. Thus, the MFP 100 can select which frequency range to use from among the 5 GHz frequency band and the 2.4 GHz frequency band and which frequency channel to use in the frequency band.

### Wireless Infrastructure Mode

In the wireless infrastructure mode, the communication apparatuses (for example, the mobile terminal apparatus 104 and the MFP 100) that communicate with one another are connected to an external AP (for example, the AP 101) controlling the network, and communication between the communication apparatuses is performed via the AP. In other words, communication between the communication apparatuses is performed via the network formed by the external AP. The mobile terminal apparatus 104 and the MFP 100 each discover the AP 101, transmit a connection request to the AP 101, and connect to the AP 101. This enables communication between the communication apparatuses in the wireless infrastructure mode via the AP 101. Note that the plurality of communication apparatuses may connect to different APs. In this case, the communication apparatuses can communicate by data being transferred between APs. Note that it is sufficient that the commands and parameters transmitted and received when the communication apparatuses communicate via the access point are as specified by Wi-Fi standards, and thus description thereof will be omitted. Also, in this case, the AP 101 determines the frequency band and the frequency channel. Thus, the AP 101 can select which frequency range to use from among the 5 GHz frequency band, the 2.4 GHz frequency band, and the 6 GHz frequency band and which frequency channel to use in the frequency band.

Processing in Response to Request to Change Connection Destination from AP to STA

The mobile terminal apparatus 104 and the MFP 100 support a function released as Wi-Fi Agile Multiband (trademark). Wi-Fi Agile Multiband is a function that enables the optimal environment to be selected according to the changing situation of the Wi-Fi network. Specifically, a STA such as the mobile terminal apparatus 104 and the MFP 100 and an AP such as the AP 101 exchange information relating to the network environment using the IEEE 802.11 series communication standard. By exchanging such information, when the network is congested, the AP can guide (change the connection destination) of the STA to another cellular service depending on the other AP, the frequency band, the channel, and the like.

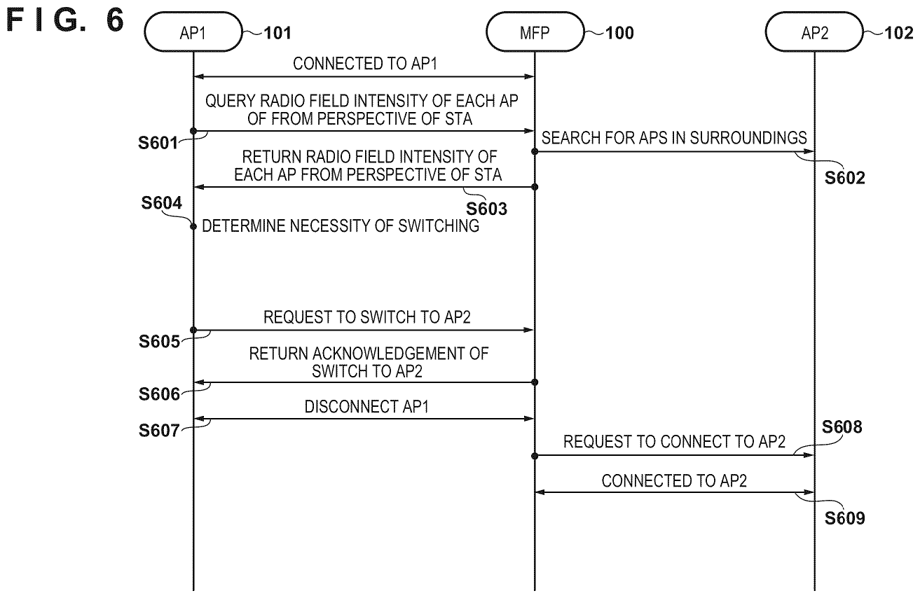

FIG. 6 is a sequence diagram of a case where the AP which is the connection destination of the MFP 100 is changed (switched) from the AP 101 to the AP 102 according to a request to change the connection destination from the AP 101. The processing executed by each apparatus in the present sequence is implement by the CPU of each apparatus reading out to the RAM and executing various types of programs stored in the ROM or similar memory of each apparatus.

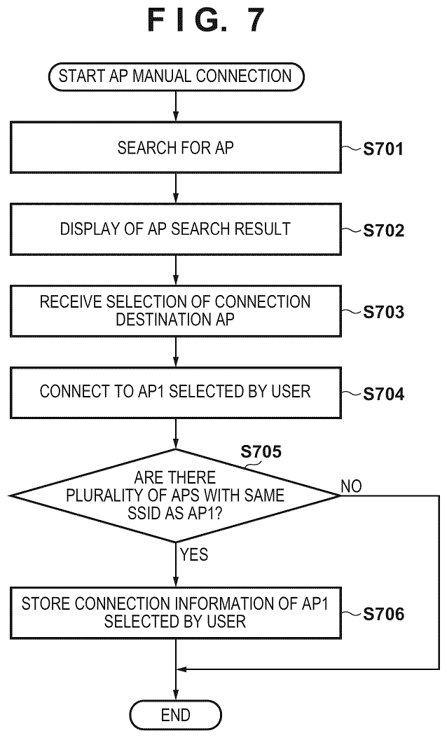

In the initial state of the processing of FIG. 6, the MFP 100 has established a connection with the AP 101 in the wireless infrastructure mode. In the present embodiment, the AP 101 is a user-set AP described below, and the connection between the MFP 100 and the AP 101 is established by the processing of FIG. 7 described below. Also, when the MFP 100 and the AP 101 connect in the wireless infrastructure mode, information of whether or not the MFP 100 supports IEEE 802.11v is obtained by the AP 101. Then, if information indicating that the MFP 100 supports IEEE 802.11v is obtained, the AP 101 executes the following processing.

In S601, the AP 101 transmits a query (measurement request) for the radio field intensity of the APs around the MFP 100 to the MFP 100. The transmitted request may be, for example, a beacon frame request or a beacon report request. In other words, the request can use a mechanism specified in the IEEE 802.11k standard.

In S602, in response to the request received in S601, the MFP 100 receives the frames transmitted by the APs in the surroundings and measures the radio field intensity. Accordingly, the radio field intensity of each one of a plurality of APs including the AP 101 and the AP 102 is measured.

In S603, the MFP 100 transmits a list of the radio field intensities of the APs surrounding the MFP 100 measured in S602 as a response to the request received in S601. Note that as the radio field intensity response, in addition to or alternatively to the information measured in S602, information stored in the RAM 214, the non-volatile memory 215, or the like of the MFP 100 may be used. The response is transmitted as a beacon report or as a measurement report, for example.

In S604, the AP 101 determines whether or not a change of the connection destination of the MFP 100 is required on the basis of the congestion status of the network obtained by the AP 101 and the radio field intensities received in S603 from the MFP 100. Causes for the AP 101 determining that a connection destination change is necessary include too many STAs connected to the AP 101 (equal to or greater than a threshold), too much communication amount between the AP 101 and the STAs connected to the AP 101 (equal to or greater than a threshold), whether or not there is radio wave interference determined on the basis of the S/N ratio or the like, AP function stop, and the like. Also, whether or not a change of the connection destination is required may be determined on the basis of the degree of congestion (number of connected STAs, communication amount) of each AP determined using communication between APs. If it is determined that a change of the connection destination of the MFP 100 is required, the SSID of the other AP designated as candidate for the post-change connection destination of the MFP 100, the channel, and the frequency band are determined. Then, the processing proceeds to S605. Note that in the present embodiment, the SSID of the other AP designated as the change destination of the connection destination is the same SSID as the SSID of the pre-change AP.

In S605, the AP 101 transmits an AP change request (connection destination change request) to the MFP 100. The connection destination change request includes information of the SSID of the other AP designated as candidate for the post-change connection destination, the MAC address, the channel, and the frequency band determined in S604. Note that a plurality of SSIDs may be designated. In the present embodiment, the same SSID is set for the APs that are switching connection destination via Wi-Fi Agile Multiband, and each AP can be identified via the MAC address. Thus, the other AP designated as candidate for the post-change connection destination can be identified via the MAC address even if the SSID is the same as that of the pre-change AP. The connection destination change request is transmitted as a BTM request, for example. In other words, a BSS transition management (BTM) request frame specified by the IEEE 802.11v standard is transmitted. In the example of FIG. 6, the AP 102 is designated as a candidate for the post-change connection destination included in the connection destination change request. In other words, in the present embodiment, the SSID of the AP 101 and the SSID of the AP 102 are the same.

In S606, if following the connection destination change request received in S605, the MFP 100 transmits a response indicating change acknowledgement (switch acknowledgement) to the AP 101. Alternatively, suppression processing to suppress a change in the connection destination AP described below may be executed. The response is transmitted as a BTM response. In the example of FIG. 6, a response indicating acknowledgement is transmitted.

In S607, the AP 101 and the MFP 100 disconnect their connection in the wireless infrastructure mode. At this time, the connection information with the AP 101 is not deleted by the MFP 100 and is stored. In S608, the MFP 100 transmits a connection request to the AP 102 to connect to the AP 102 designated in the connection destination change request received in S605.

Accordingly, in S609, the MFP 100 and the AP 102 establish a connection in the wireless infrastructure mode. When a connection between the MFP 100 and the AP 102 in the wireless infrastructure mode is established, the connection information for the AP 101 is deleted.

In this manner, the MFP 100 (STA) can change the connection destination from the AP 101 to the AP 102 on the basis of a connection destination change request from the originally connected AP 101. The AP 101 and the AP 102 may be APs installed at different places. In other words, the MFP 100 can switch to another AP installed at a location different from that of the originally connected AP via the processing of FIG. 6. Also, the AP may support each different frequency bands of the plurality of frequency bands (two or three of the 2.4 GHz band, the 5 GHz band, and the 6 GHz band) provided by the same device. In other words, the MFP 100 can switch to a different frequency band provided by the same apparatus as the originally connected AP via the processing of FIG. 6. For example, the connection destination can be changed to an AP of a 6 GHz band on the basis of the connection destination change request.

Note that in an example of the present embodiment described herein, with a mechanism that is compliant with Wi-Fi Agile Multiband, a measurement request and a connection destination change request from the AP is transmitted and the STA responds. However, no such limitation is intended. The present embodiment is also applicable to an example using a mechanism different from the example described above in which, in response to the measurement request and the connection destination change request transmitted from the AP, the STA responds and changes the connection destination AP (switches, deletes, and adds the AP corresponding to the connection destination).

Depending on the state of the MFP 100 during the execution of a job or the like, a change of the connection destination AP based on a request to change the connection destination AP transmitted from the currently connected AP may not be preferable. In the present embodiment, in a case where a change of the connection destination AP based on a change request is not preferable, as processing to suppress a change of the connection destination in response to a change request, one or a combination of the following suppression processing may be executed. The following suppression processing includes processing so that a change of the connection destination AP based on a change request is not performed and processing that makes a change harder to be performed.

Suppression Processing 1: Even if the change request described in S605 is received, a change of the connection destination AP based on the received connection request is not performed, and a response to the change request is not returned or a response indicating the denial of the change request (indicating that a change of the connection destination AP will not be performed) is transmitted to the currently connected AP. When a denial response is transmitted, the connection destination change priority of other STAs connected to the AP currently connected to the MFP 100 increases and the connection destination change priority of the MFP 100 that returned the denial response decreases. As a result, there is a possibility that the connection with the currently connected AP can be maintained. Also, in a case where a response is not returned (a case of being ignored), the currently connected AP maintains the connection with the MFP 100 as it waits for a response until the response wait time times out. Accordingly, in the case of a configuration in which connection is immediately disconnected when a certain response to a change request is received from the MFP 100, not responding, as opposed to returning a response, can increase the amount of time the connection with the currently connected AP is maintained. Thus, for example, the processing may be different depending on the reason, with a denial response being given if there is a weak reason and the change request being ignored if there is a strong reason based on the information of the change reason included in the change request. The change reason can be determined on the basis of information of which reason, including, for example, a request mode included in a BTM request, is applicable. For example, in a case where the disassociation imminent bit of the request mode or the BSS termination include bit is 1, the change reason can be determined to be a change request with a strong reason. Otherwise, it can be determined to be a weak change reason.

Suppression Processing 2: In response to the measurement request described in S601, a response (false response) is given of information relating to the radio wave reception status (signal reception status) of the non-connected APs other than the currently connected AP indicating that the radio wave status is different from the status actually measured (low signal quality). In this case, in response to receiving a measurement request, measurement may be actually performed and a response given, or measurement may not be actually performed and a response given. Specifically, in the response (beacon report or the like) described in S603, for the quality of a signal measured as a signal received from a non-connected AP, a value corresponding to the decreased received signal strength is used as the response and/or a value corresponding to the increased noise (signal-to-noise ratio) is used as the response. Alternatively, a response may be given with the contents not including at least one piece of information of the non-connected APs. Also, on the basis of previously measured information relating to the non-connected APs, processing may be executed so that the response has the received signal strength made into a significantly low value or the noise made into a significantly increased value. Also, measurement (AP search) may not be actually performed when a measurement request is received, and a response may be given including good received signal strength and noise status related only to the connected AP and not including information of the non-connected APs. Responding to a measurement request with a response not including information relating to the non-connected APs corresponds to content indicating that another non-connected AP could not be found even with an AP search. In this manner, a connection destination change request for changing from the currently connected AP to another AP can be suppressed from being sent. Thus, a change of the connection destination in response to a connection destination change request is suppressed from occurring.

Suppression Processing 3: Connection with the currently connected AP is disconnected, information indicating that the change request is not supported is notified, and the same AP is reconnected to. Specifically, the wireless connection with the currently connected AP is disconnected, and data of an association request frame including information indicating that IEEE 802.11v is not supported is generated as preparation for reconnecting the wireless connection. Thereafter, AP connection processing is executed using the generated data of the association request frame. As a result, in a case where an association request frame including information indicating that IEEE 802.11v is not supported is generated, a connection would be established with the AP as an electronic device that does not support (unsupported) an agile multiband function. This would cause the currently connected AP to recognize that the MFP 100 does not support IEEE 802.11v and cause a wireless connection destination change request to not be transmitted to the MFP 100. In this manner, since a connection destination change request is not sent to the MFP 100, the wireless connection between the MFP 100 and the currently connected AP is likely to be maintained. Also, when the currently connected AP recognizes that the MFP 100 does not support IEEE 802.11v, transmission to the MFP 100 of a measurement request (the request described in S601) from the currently connected AP is prevented. Thus, measurement (AP search) in response to the measurement request of the MFP 100 and responding to the measurement request (processing of S603) can also be suppressed. Accordingly, the processing load and the power consumption can be reduced. Also, resources can be divided between other processes.

A state in which change of the connection destination AP based on a change request is not preferable includes a state in which print data is being received, for example. During reception of print data in the MFP 100, for example, a state occurs in which a part of the print data of the image to be printed has been received from the mobile terminal apparatus 104, the partner device) and the remaining part of the print data has not been received. In the MFP 100, printing is performed by, when the part of the print data to be printed on one sheet is received, this received part is printed (for example, one line is received then printed), then when the next part of the data is received, it is printed, and so on. During reception of the print data, if a change of the connection destination AP based on a connection destination change request is performed, a time lag occurs in conjunction with the connection destination change processing, leading to the possibility of a decrease in the print quality such as printing unevenness. Also, there is the possibility of poor communication with the mobile terminal apparatus 104, the partner device, after the connection destination change and of failure to print due to the next piece of data being unable to be received. Accordingly, during reception of print data, as processing to suppress a change of the connection destination in response to a change request, at least one process from among the suppression processing 1 and the suppression processing 2 described above may be executed or the suppression processing 3 described above may be executed before the start of print data reception.

### User-Set AP

The MFP 100 operating as a STA can connect to the AP by a user operation being performed to select and determine an external AP corresponding to the connection destination of the MFP 100. In the following description, the AP determined by the user operation may be referred to as the “user-set AP”. The user-set AP is, for example, an AP set as the connection destination AP of the MFP 100 by the user operating the MFP 100, the mobile terminal apparatus 104, or the like. Also, the user-set AP can be considered as the AP the MFP 100 is connected to before connection destination switching is performed via Wi-Fi Agile Multiband. To paraphrase further, the user-set AP is an AP different from the AP the MFP 100 connects to when connection destination switching is performed via Wi-Fi Agile Multiband. Note that the connection destination switching via Wi-Fi Agile Multiband is as described with reference to FIG. 6. Also, the establishment of a connection between the user-set AP and the MFP 100 is as described below with reference to FIG. 7. The user-set AP is a high performance AP, for example, that can communicate in the 5 GHz frequency band. Consider a case in which the user performs an operation on the MFP 100 and, after the specific high performance AP 101 (user-set AP) in the extended service set (ESS) is connected to, a decrease in the radio wave status or the like triggers a connection destination AP change request which when received causes an automatic switch of the AP to occur and another AP2 to be connected to. By connecting to the other AP2, a temporary decrease in the radio wave status and other such trouble is avoided. However, thereafter, the connection to the AP2 is maintained, and the user can no long use the high performance AP 101.

Regarding this, in the present embodiment, after the automatic change of connection destination from the user-set AP to another AP, if a predetermined condition is satisfied, even if the connection destination AP change request is not received, the connection destination is autonomously changed (returned) back to the user-set AP. Such a configuration suppresses a state in which the user-set AP is not connected to from continuing.

The user-set AP will now be described with reference to FIG. 7. FIG. 7 is a flowchart illustrating an example of the processing for determining the AP to be the connection destination of the MFP 100. In the present flowchart, the processing executed by the MFP 100 is implemented by the CPU 212 reading out to the RAM 214 various types of programs stored in the ROM 213 or similar memory and executing them. Also, the processing of FIG. 7 described herein is an example of the processing executed in response to a predetermined operation of the operation display unit 220 by the user being received.

In the present embodiment, before the processing of FIG. 7 is started, the AP 101 and the AP 102 are set with the same SSID. For example, the AP 101 and the AP 102 are APs that support Wi-Fi Agile Multiband, thus the user sets the AP 101 and the AP 102 with the same SSID.

In S701, the CPU 212 performs an AP search. An AP search is processing to search for APs in the surroundings of the MFP 100. Specifically, the CPU 212 controls the wireless unit 226 and executes processing to search for connection destination candidate APs in the environment where the MFP 100 is installed. For example, the CPU 212 transmits a probe request. Thereafter, when the CP receives a probe response or a beacon (information autonomously and periodically transmitted by the AP) transmitted from the AP, the CPU 212 performs a search for APs in the surroundings of the MFP 100. Also, in the AP search, information obtained from the APs in the surroundings includes, for example, at least one of information indicating the service set identifier (SSID) and radio field intensity of the AP, the frequency range, the media access control (MAC) address, and the security system.

In S702, the CPU 212 displays the AP search result on the operation display unit 220. For example, the CPU 212 displays a list of APs discovered in the surroundings of the MFP 100 as the AP search result. For example, the CPU 212 may display a list of the identification information of the discovered APs. The identification information is the SSIDs, for example. Note that the identification information may be the device names, the MAC address, or the like. Also, for example, the list of identification information described above may be displayed as an interface that can receive a selection instruction by a user.

In S703, the CPU 212 receives a selection instruction for the connection destination AP of the MFP 100. Specifically, the CPU 212 receives a selection instruction by a user from the AP search results displayed in S702. For example, the user-set AP described above is the AP that receives a selection instruction by the user in the present processing. Also, in the example of the present embodiment described here, the AP 101 is selected as the user-set AP. Also, in S703, the CPU 212 may display an interface that can receive an input of authentication information such as the password for the user-set AP.

In S704, the CPU 212 executes connection processing to connect to the user-set AP that received a selection instruction in S703. In S704, in a case where the connection processing is executed, the CPU 212 stores the connection information of the connection destination AP in the non-volatile memory 215 or the like as connection information of the currently connected AP. The currently connected AP connection information can be considered as information indicating the AP last connected to from among the APs that MFP 100 has previously connected to. Also, a plurality of pieces of connection destination AP connection information may be stored. For example, the connection information of the APs previously connected to may be stored in a time series.

In S705, the CPU 212 determines whether or not a plurality of APs with the same SSID as the user-set AP in S703 exist in the AP search result of S701. In a case where the CPU 212 determines that there are a plurality of APs with the same SSID, the processing proceeds to S706. In a case where the CPU 212 determines that there are no APs with the same SSID, the processing of FIG. 7 ends.

In S705, in a case where it is determined by the CPU 212 that there are no APs with the same SSID, it is considered that a beacon request or a connection destination change request will not be received from the AP 101. This is because it can be determined there are no APs that support the Wi-Fi Agile Multiband function and that a connection destination AP change using this function will not be performed. In other words, the connection destination AP of the MFP 100 will not be changed to another AP other than the AP 101 on the basis of a request to change from the AP 101. Thus, in the case of no in S705, the CPU 212 ends the processing of FIG. 7 without storing the connection information of the AP 101. On the other hand, in a case where it is determined that there is an AP with the same SSID, it is determined that the SSID that is the same for the APs that support the Wi-Fi Agile Multiband function has been preset by the user. Thus, in this case, it is determined that a beacon request or a connection destination change request will be received from the AP 101.

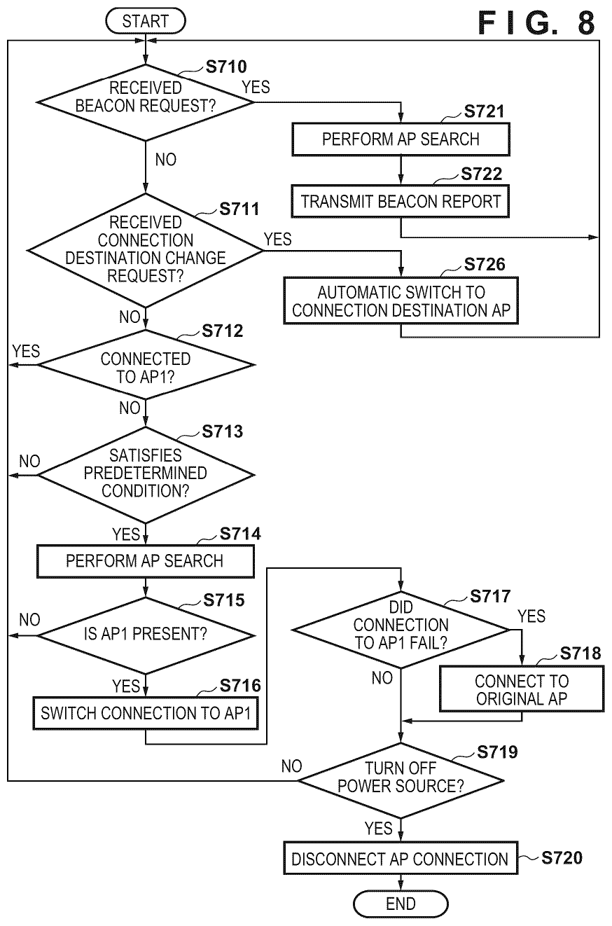

In S706, the CPU 212 stores the connection information of the AP 101, which is the user-set AP, in the non-volatile memory 215. The connection information is information used by the MFP 100 to connect to the AP. The connection information, for example, is one or more of information indicating the SSID, the MAC address, the BSSID, and the security system and the password. The connection information, for example, is used as information for determining whether or not the AP 101 (user-set AP) is currently connected to and returning the connection destination to the original AP 101 after the connection destination has changed from the AP 101 to another AP in the processing of FIG. 8 described below. The connection information stored in S706 and the connection information stored in S704 are distinct from one another. The storage area used in S706 and the storage area used in S704 may be different, or the connection information may be differentiated by additional information such as a flag. The connection information stored in S706, that is, the connection information of the user-set AP, is continuously stored without being deleted even when the connection destination AP is changed via the Wi-Fi Agile Multiband function.

In the example described above, the user sets an external AP to connect to on the panel (operation display unit 220) of the MFP 100. However, the method for setting an external AP for the MFP 100 to connect to is not limited to this example. An external AP for the MFP 100 to connect to may be set on a device other than the MFP 100. For example, an external AP for the MFP 100 to connect to may be set on the mobile terminal apparatus 104. Such examples will be described below.

A program for network setup processing for transmitting AP setting information to the MFP 100 is stored in the mobile terminal apparatus 104. The program for network setup processing is an application program (an application for setup) for performing connect settings of the AP to be connected to by the MFP 100 and may also have a function other than the network setup function. For example, the application for setup may have a function for causing the MFP 100 to print, a function for causing the MFP 100 to scan a set document, a function for confirming the state of the MFP 100, and the like. Also, the application for setup may have a function for transmitting the information obtained from the MFP 100, personal information of the user obtained by the mobile terminal apparatus 104, and the like to a service management server (not illustrated). The application for setup, for example, is stored internally by being installed from an external server via Internet communication. Also, the application for setup is an application program provided by the vendor of the MFP 100, for example.

The MFP 100 operates in network setup mode in order to execute the network setup processing. Here, the network setup mode of the MFP 100 will be described.

The MFP 100 can operate in the network setup mode. The trigger for starting the operations of the MFP 100 in the network setup mode may be, for example, the user pressing a button for network setup mode or the MFP 100 being activated (powered on) for the first time after shipment. The button for network setup mode may be a hard (physical) button of the MFP 100 or may be a software button displayed on the operation display unit 220 by the MFP 100.

The MFP 100 activates Wi-Fi communication when operation in the network setup mode is started. Specifically, the MFP 100 activates the AP (AP for setup) inside the MFP 100 dedicated to the network setup mode as Wi-Fi communication activation processing. The SSID of the AP for setup corresponds to the unique SSID described above. Accordingly, the MFP 100 is put in a state where a direct connection can be established with the mobile terminal apparatus 104 via Wi-Fi. The connection information (SSID and password) for connecting to the AP for setup is stored in advance in the application for setup installed on the mobile terminal apparatus 104, and the MFP 100 recognizes in advance the connection information for connecting to the AP for setup. Thus, different from the connection information of the AP activated in the direct connection mode, the connection information for connecting to the AP for setup cannot be discretionarily changed by the user. Note that in the network setup mode, the MFP 100 may connect to the mobile terminal apparatus 104 via Wi-Fi Direct (WFD) instead of normal Wi-Fi. In other words, the MFP 100 may operate as a group owner and receive a setting command from the mobile terminal apparatus 104 via WFD communication. Also, in the network setup mode, the MFP 100 may connect to the mobile terminal apparatus 104 via Bluetooth. Here, Bluetooth includes Bluetooth Classic and Bluetooth Low Energy (BLE). In other words, for example, the MFP 100 may operate as a slave apparatus in BLE in the network setup mode and receive a setting command from the mobile terminal apparatus 104 via BLE communication. Also, in the network setup mode, the MFP 100 may be able to perform both network setup via Wi-Fi and network setup via BLE. In other words, the MFP 100 may activate both Wi-Fi communication and BLE communication when operation in the network setup mode is started. Specifically, when operation in the network setup mode is started, the MFP 100 may activate both the AP for setup and an advertise state in which advertise information can be transmitted via BLE enabling a BLE connection. Also, the MFP 100 may receive a setting command from the mobile terminal apparatus 104 via wired LAN or USB.

As described above, the MFP 100 operates in the network setup mode for performing network setup of the MFP 100 according to a predetermined condition including the user pressing a button or the time of initial installation. In a case where the MFP 100 operates in the network setup mode, the MFP 100 controls the wireless unit 226 and operates as an AP for setup activated only during operation in the network setup mode. The AP for setup is an access point that is different from the access point activated when in the SoftAP mode described above. The SSID of the AP for setup includes a predetermined character string that is recognizable by the application for setup of the mobile terminal apparatus 104.

Also, the MFP 100 operating in the network setup mode uses a predetermined communication protocol (communication protocol for setup) in the communications with the mobile terminal apparatus 104 connected to the AP for setup. The communication protocol for setup is specifically the simple network management protocol (SNMP), for example.

After operation in the network setup mode has started and a predetermined amount of time has elapsed, the MFP 100 stops operation in the network setup mode and deactivates the AP for setup. Also, in a case where connection information for connecting to an external AP and a change wireless communication operation mode instruction are received from the mobile terminal apparatus 104 while in the network setup mode, the AP for setup is deactivated.

In the present example, the mobile terminal apparatus 104 requests the MFP 100 for a list of access points via the Wi-Fi connection between the mobile terminal apparatus 104 and the MFP 100 operating in the network setup mode via the application for setup. When the request is received, the MFP 100 performs an AP search (performs AP search). The MFP 100 transmits a list of the access points to the mobile terminal apparatus 104 via the Wi-Fi connection. Note that the list transmitted here is a list of one or more access points that the MFP 100 can connect to discovered by the MFP 100 performing an AP search. Here, the AP 101 and the AP 102 are included in the list. The AP 101 and the AP 102 are preset with the same SSID. Here, the SSID and the MAC address of the AP 101 and the AP 102 are as follows.
AP 101: SSID-A, MAC-X
AP 102: SSID-A, MAC-Y

Then, the mobile terminal apparatus 104 displays the list including the AP 101 and the AP 102 described above on the display unit 420. Since the SSID and the MAC address are displayed in the list, the user can identify the AP (in other words, the user-set AP) they wish to set with the MFP 100. Here, the user selects the AP 101 (SSID-A, MAC-X) (selects connection destination AP). The mobile terminal apparatus 104 transmits the connection information of the AP 101 to the MFP 100. Note that the connection information may be transmitted by Bluetooth, wired LAN, USB, and the like instead of by a wireless direct connection. The connection information includes, for example, the SSID and the MAC address of the access point selected from the list and the password input by the user.

The MFP 100 recognizes the SSID selected by the user is one of a plurality of identical SSIDs via the results of the AP search performed. Then, the MFP 100 stores the SSID-A (MAC-X) selected by the user as the connection information (stores connection information).

### Processing to Change Connection Destination AP of MFP 100

Next, processing to change the connection destination AP of the MFP 100 according to a connection destination change request received from the currently connected AP and processing to change the connection destination to the original connection destination AP 101 when a predetermined condition is satisfied will be described.

FIG. 8 is a flowchart illustrating processing to change the connection destination AP of the MFP 100 according to a connection destination change request received from the currently connected AP and processing to change the connection destination to the original connection destination user-set AP when a predetermined condition is satisfied. The processing in FIG. 8 is implemented by the CPU 212 reading out a program stored in the non-volatile memory 215 onto the RAM 214 and executing the program, for example.

In S710, the CPU 212 determines whether or not a beacon frame request has been received from the currently connected AP. In a case where the CPU 212 determines that a beacon frame request has been received, the processing proceeds to S721. In a case where it is determined that a beacon frame request has not been received, the processing proceeds to S711. A beacon frame request corresponds to a query (measurement request) for the radio field intensity of the APs around the MFP 100 described in S601. In other words, a beacon frame request is a request to search for APs around the MFP 100.

In S721, the CPU 212 performs an AP search. An AP search is processing to search for APs in the surroundings of the MFP 100 as in S701.

In S722, the CPU 212 transmits the result of the AP search performed in S721 to the currently connected AP as a beacon report. Here, the CPU 212 transmits a beacon report including information of all of the APs discovered by the AP search performed in S721 to the currently connected AP. In other words, in a case where the user-set AP and other APs are both included in the AP search result of S721, the CPU 212 transmits a beacon report including both the user-set AP and the other APs. After S722, the CPU 212 returns processing to S710.

In S711, the CPU 212 determines whether or not a connection destination change request has been received from the currently connected AP. Receiving a connection destination change request here corresponds to S605 of FIG. 6. In a case where it is determined that a connection destination change request has been received, the processing proceeds to S726. In S726, the CPU 212 changes the connection destination AP from the currently connected AP to an AP recommended in the connection destination change request. In S726, processing from S606 to S609 of FIG. 6 is executed, and thereafter, the processing from S710 is repeated. In a case where it is determined that a connection destination change request has not been received, the processing proceeds to S712.

In S712, the CPU 212 determines whether or not the MFP 100 is connected to the user-set AP. In a case where it is determined that the user-set AP is connected to, the processing from S710 is repeated. On the other hand, in a case where it is determined that the user-set AP is not connected to, that is, another AP is connected to, the processing proceeds to S713. In the present example, the user-set AP is the AP 101. Specifically, for example, the CPU 212 stores the connection information of the user-set AP in S706 as described above. In a case where the connection information of the currently connected AP is the connection information of the user-set AP, the CPU 212 may determine that the user-set AP is connected to.

In S713, the CPU 212 determines whether or not a predetermined condition has been satisfied. In a case where it is determined that the predetermined condition is satisfied, the processing proceeds to S714. On the other hand, in a case where it is determined that the predetermined condition is not satisfied, the processing from S710 is repeated. The predetermined condition is a condition for the MFP 100 to change (return) the connection destination to the user-set AP. For example, the CPU 212 determines that the predetermined condition is satisfied if the conditions given below is satisfied.

(1) A predetermined amount of time has elapsed since the connection destination has switched from the AP 101 to an AP other than the AP 101.

(2) The MFP 100 is not currently executing a job. Note that a job here may include a print job or a scan job.

(3) The MFP 100 is not currently printing.

(4) The MFP 100 is not currently reading a document.

(5) The MFP 100 is not currently communicating with an external information device such as the servers 103 and 105 or the mobile terminal apparatus 104.

(6) A predetermined amount of time has elapsed with the MFP 100 in a state of not being busy and a user operation not being performed. In other words, a predetermined amount of time has elapsed with the MFP 100 being in an idle state. Note that the MFP 100 not being busy is a state in which a job instruction such as (2) has not been received from an external information device.

(7) The MFP 100 stores the connection information of the AP 101.

(8) A predetermined amount of time has elapsed since a failure to change the connection to the AP 101.

(9) The MFP 100 is not operating as an AP (for example, the MFP 100 is not operating in the SoftAP mode). Also, the frequency band at which the MFP 100 operates as an AP and the frequency band of the post-change connection destination AP (AP 101) are the same. Condition (9) can be reworded as the frequency band at which the MFP 100 operates as an AP and the frequency band of the post-change connection destination AP (AP 101) not being different.

In the present embodiment, as described above with conditions (1) to (9), it may be determined that the predetermined condition is satisfied in S713 if all of the conditions (1) to (9) are satisfied, or it might be determined that the predetermined condition is satisfied if at least one of the conditions (1) to (9) is satisfied. Also, a state of the MFP 100 other than the conditions (1) to (9) may be used as a criteria for the determination of S713. The determination of S713 can be reworded as determining whether or not at least one of the state of the MFP 100 relating to a change of the connection destination AP and the state of the MFP 100 not relating to a change of the connection destination AP is the predetermined state.

In S714, the CPU 212 performs an AP search. An AP search is processing to search for APs in the surroundings of the MFP 100 as in S701.

In S715, the CPU 212 determines whether or not the user-set AP is included in the AP search result. In a case where the user-set AP is determined to be included, the processing proceeds to S716. On the other hand, in a case where the user-set AP is determined to not be included, the processing from S710 is repeated. The determination of S715 specifically includes, for example, the CPU 212 comparing the AP search result and the connection information of the user-set AP stored in S706. For example, in a case where the AP search result includes an AP with a MAC address that is the same MAC address as the user-set AP, the CPU 212 proceeds the processing to S716.

In S716, the CPU 212 performs control to change the connection destination AP from the other AP to the user-set AP (AP 101). Specifically, for example, the CPU 212 first disconnects the connection with the currently connected AP (AP 102). At this time, the connection information of the disconnected currently connected AP is temporarily stored internally until the connection with the post-change connection destination AP is successful. Accordingly, even in a case where the connection with the post-change connection destination AP fails, since the connection information of the pre-change connection destination AP is temporarily stored, the CPU 212 can re-connect with the pre-change connection destination AP. Also, a plurality of pieces of connection destination AP connection information may be able to be stored. The CPU 212 uses the connection information of the user-set AP (AP 101) stored in S706 to attempt processing to connect to the AP 101.

In S717, the CPU 212 determines whether or not connection to the user-set AP has failed. In a case where it is determined to have not failed (been successful), the information indicating the pre-change connection destination AP temporarily stored in S716 is deleted, and the processing proceeds to S719. When it is determined to have failed, the processing proceeds to step S718. For example, at this time, in a case where the AP 101 is powered off or the MFP 100 is located outside of the communication area with the AP 101, connection with the user-set AP may fail.

In S718, the CPU 212 uses the connection information of the pre-change connection destination AP stored in S716 to execute connection processing to connect to the pre-change connection destination AP. In this manner, even if an attempt to change the connection destination AP of the MFP 100 to the user-set AP fails, the MFP 100 can re-connect to the pre-change connection destination AP.

In S719, the CPU 212 determines whether or not an instruction to turn off the power of the MFP 100 has been received. In a case where it is determined that an instruction to turn off the power of the MFP 100 has been received, the processing proceeds to S720. On the other hand, in a case where it is determined that an instruction to turn off the power of the MFP 100 has not been received, the processing from S710 is repeated. An instruction to turn off the power is a user operation of a power button (not illustrated) that can switch the power of the MFP 100 on and off, for example. In S720, the CPU 212 executes processing to disconnect the connection between the MFP 100 and the AP, and then the processing of FIG. 8 ends.

As described above, in the present embodiment, after the automatic change of connection destination from the user-set AP to another AP, if a predetermined condition is satisfied, even if the connection destination AP change request is not received, the connection destination is autonomously changed back to the user-set AP. Such a configuration suppresses a state in which the user-set AP is not connected to from continuing.

### Second Embodiment

The differences between the second embodiment and the first embodiment will be described below. In the first embodiment described above, in a case where the predetermined condition is satisfied, the MFP 100 autonomously changes the connection destination AP to the user-set AP without receiving a connection destination change request. In the present embodiment, in addition to an autonomously change of the connection destination to the user-set AP, after a connection destination change request is received, connecting to the user-set AP is performed with priority.

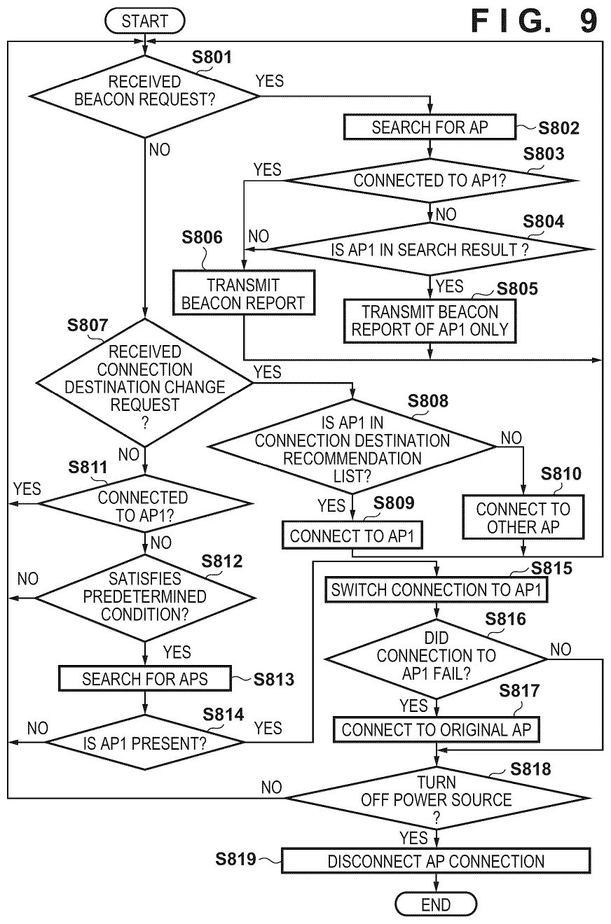

FIG. 9 is a flowchart illustrating processing to change the connection destination AP of the MFP 100 according to a connection destination change request received from the currently connected AP and processing to change the connection destination to the original connection destination user-set AP when a predetermined condition is satisfied. The processing in FIG. 9 is implemented by the CPU 212 reading out a program stored in the non-volatile memory 215 onto the RAM 214 and executing the program, for example.

S801, S802, S806, S807, and S811 to S819 are the same as S710, S721, S722, and S711 to S720 of FIG. 8 and thus description thereof will be omitted.

In S803, the CPU 212 determines whether or not the MFP 100 is connected to the user-set AP. Here, the user-set AP is the AP 101. In a case where it is determined that the user-set AP is not connected to, the processing proceeds to S804. A case where it is determined that the user-set AP is not connected to corresponds to a case where, specifically for example, the MFP 100 is connected to an AP different from the user-set AP. Also, a case of the MFP 100 being connected to an AP different from the user-set AP corresponds to, specifically for example, a state after the MFP 100 has switched the connection destination from the user-set AP to the AP 102, which is an AP different from the user-set AP, via a mechanism compliant with Wi-Fi Agile Multiband as described in FIG. 6. On the other hand, in a case where it is determined that the user-set AP is connected to, the processing proceeds to S806. A case where it is determined that the user-set AP is connected to corresponds to a case in which, after the MFP 100 has connected to the user-set AP, the MFP 100 has not switched the connection destination via a mechanism compliant with Wi-Fi Agile Multiband. Also, the CPU 212 stores the connection information of the user-set AP as described above. In a case where the connection information of the currently connected AP is the connection information of the user-set AP, the CPU 212 may determine that the user-set AP is connected to. Also, in a case where the connection information of the currently connected AP is not the connection information of the user-set AP, the CPU 212 may determine that the user-set AP is not connected to.

In S804, the CPU 212 determines whether or not the user-set AP is included in the AP search result of S802. In a case where the user-set AP is determined to be included, the processing proceeds to S805. On the other hand, in a case where the user-set AP is determined to not be included, the processing proceeds to S806. Specifically, for example, the CPU 212 determines this on the basis of the connection information of the user-set AP stored in S706. For example, the CPU 212 may determine, from the connection information of the user-set AP, whether or not the AP with the same MAC address as the MAC address of the connection information of the user-set AP is included in the AP search result. In a case where the AP with the same MAC address as the user-set AP is included in the AP search result, the processing proceeds to S805. On the other hand, in a case where the AP with the same MAC address as the user-set AP is not included in the AP search result, the processing proceeds to S806.

In S805, the CPU 212 transmits (responds with) a beacon report including only the user-set AP to the currently connected AP. Note that in the present processing, in a case where only the user-set AP is included in the AP search result of S802, naturally, a beacon report including only the user-set AP would be transmitted even if both the user-set AP and another AP are included in the AP search result of S802. A beacon report is a list of radio field intensities as described in S603. For example, the CPU 212 may select only the user-set AP from the result of the AP search performed in S802 and transmit the user-set AP to the currently connected AP (transmission source of the beacon frame request) as a beacon report including only the user-set AP. Also, the CPU 212 may exclude the APs different from the user-set AP from the AP search result and transmit it as a beacon report. In this manner, it can be expected that the connection destination recommended (candidate) AP list included in the connection destination change request from the currently connected AP includes the user-set AP. After S805, the CPU 212 returns the processing to S801.

In S807, the CPU 212 determines whether or not a connection destination change request has been received from the currently connected AP. In a case where it is determined that a connection destination change request has been received, the processing proceeds to S808.

In S808, the CPU 212 determines whether or not the user-set AP (AP 101) is included in the connection destination AP recommended list included in the connection destination change request received from the currently connected AP. In a case where the user-set AP is determined to be included, the processing proceeds to S809. On the other hand, in a case where the user-set AP is determined to not be included, the processing proceeds to S810. Specifically, for example, the CPU 212 determines this using the connection information of the user-set AP (AP 101) stored in S706. For example, the CPU 212 determines whether or not an AP with the same MAC address as the MAC address in the connection information of the user-set AP is included in the connection destination AP recommended list. Note that the connection destination AP recommended list is a list of APs that are candidates for the post-change connection destination described in S604 and S605. Also, in the present embodiment, as described above, if the determination of S804 is yes, a beacon report including only the user-set AP is transmitted in S805. Then, if a beacon report including only the user-set AP is transmitted, this means that only the user-set AP is included in the connection destination AP recommended list. Thus, in the present embodiment, in a case where a beacon report including only the user-set AP is transmitted in S805, the result of the determination of S808 is yes.

In S809, the CPU 212 connects to the user-set AP (AP 101) included in the connection destination AP recommended list. At this time, the CPU 212 stores the connection information of the user-set AP as the connection information of the currently connected AP in the non-volatile memory 215 separate to the connection information stored in S706. Thereafter, the processing from S801 is repeated.

In S810, the CPU 212 changes the connection destination to the AP selected by the user from the connection destination AP recommended list. Thereafter, the processing from S810 is repeated. Also, the CPU 212 stores the connection information of the AP selected by the user as the connection information of the currently connected AP in the non-volatile memory 215.

In this manner, in a case where the connection destination AP recommended list includes the user-set AP, control is performed so that the user-set AP is made the connection destination.

In the present embodiment, processing to change the connection destination AP is executed in S809 and S810. However, in a case where the MFP 100 is in a printing state or similar state which may have execution of its processing affected if the connection destination AP is changed, control is performed so that the connection destination AP is not changed. An example of a state of the MFP 100 which may be affected is printing being performed. However, other states may also be applicable. For example, such states of the MFP 100 may include reading a document, executing a job, and communicating with an external information device. Also, in a case where there is a restriction where, unless the frequency band when the MFP 100 is operating as an AP (operating in the SoftAP mode, for example) and the frequency band when operating as a STA are the same, simultaneous operation cannot be performed, control may be performed so that the connection destination is not changed if the restriction applies to the frequency band of the post-change connection destination AP.

As described above, according to the present embodiment, a plurality of APs with the same SSID are present around the MFP 100, and the user selects one the these (the user-set AP) for connection. Thereafter, if the connection destination changes to another AP, the connection destination is changed to the user-set AP if a connection destination change request is not received from the other AP and the predetermined condition is satisfied. Also, in a case where a connection destination change request is received from the other AP, control is performed to change to the user-set AP if the user-set AP is included in the connection destination AP recommended list. This suppresses a state in which the user-set AP is not connected to from continuing.

Note that the various types of control described above performed by the CPU 212 may be performed by a single piece of hardware or the processing may be shared by a plurality of pieces of hardware (for example, a plurality of processors and circuits) to perform control of the entire apparatus.

Also, in the embodiment described above, an example applicable to an MFP has been described. However, no such limitation is intended. Instead of an MFP, any wireless device that can function as a STA to execute processing in response to a connection destination change request from an AP may be used. In other words, the present invention is applicable to a personal computer, a PDA, a tablet terminal, a smartphone or similar mobile phone terminal, a music player, a game console, an electronic book reader, a smartwatch, and various types of measurement apparatuses (sensor apparatuses) such as a thermometer and a hygrometer. Also, the present invention is applicable to a digital camera (including a still camera, a video camera, a network camera, and a security camera), a printer, a scanner, and a drone. Also, the present invention is applicable to an image output apparatus, an audio output apparatus (for example, a smart speaker), a media streaming player, and a wireless LAN client (adapter) that can connect to a USB terminal or a LAN cable terminal. An image output apparatus includes an apparatus such as a set top box, for example, that obtains (downloads) moving image and still images from the Internet specified by a URL in an instruction from an electronic device and outputs these to a display device connected via a HDMI (registered trademark) image output terminal or the like. In this manner, streaming playback is achieved on a display device, and mirroring display (displaying content displayed on an electronic device also on a display device) is achieved. Also, the image output apparatus includes a television, hard disk recorder, Blu-ray recorder, DVD recorder, or similar media player; a head-mounted display, a projector, a television, a display apparatus (monitor), and a signage apparatus. Also, the present invention is applicable to a device that can connect via Wi-Fi to an air conditioner, a refrigerator, a washing machine, a vacuum cleaner, an open, an electronic microwave, a lighting fixture, a heating device, a cooling device, or any so-called smart home appliances.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-191128, filed Nov. 8, 2023, which is hereby incorporated by reference herein in its entirety.

What is claimed is:

1. An electronic device that can communicate with an external access point, comprising:
at least one processor and at least a memory coupled to the at least one processor and having instructions stored thereon, and when executed by the at least one processor, acting as:
a connection unit configured to establish a connection between a first access point and the electronic device,
a first reception unit configured to receive, from the first access point, a first change request to request change of a connection destination of the electronic device,
a first change unit configured to change, on a basis of reception of the first change request, the connection destination of the electronic device to a second access point included in one or more access points corresponding to information included in the first change request, and
a second change unit configured to change, on a basis of a predetermined amount of time elapsing since the connection destination of the electronic device has changed to the second access point on a basis of reception of the first change request, the connection destination of the electronic device to the first access point without reception of a second change request to request change of the connection destination of the electronic device from the second access point.

2. The electronic device according to claim 1, wherein
the connection destination of the electronic device is changed to the first access point, on a basis of the predetermined amount of time elapsing since the connection destination of the electronic device has changed to the second access point on a basis of reception of the first change request and the first access point being included in one or more access points surrounding the electronic device discovered via a search executed by the electronic device.

3. The electronic device according to claim 1, further acting as:
a second reception unit configured to receive a first request requesting for information relating to one or more access points surrounding the electronic device from the first access point after the connection destination of the electronic device has changed to the second access point,
a determination unit configured to determine whether or not the first access point is included in one or more access points surrounding the electronic device discovered via a search executed by the electronic device,
a first control unit configured to perform control so that information relating to the first access point is transmitted as a response to the first request on a basis of the first access point being included in the one or more access points surrounding the electronic device discovered via a search executed by the electronic device and information relating to an access point other than the first access point, from among the one or more access points surrounding the electronic device discovered via a search executed by the electronic device, is not transmitted, and
a third reception unit configured to receive the second change request to request change of the connection destination of the electronic device from the second access point after a response to the first request is transmitted,
wherein the second change request is transmitted to the electronic device on a basis of a response to the first request.

4. The electronic device according to claim 3, further acting as:
a second control unit configured to perform control so that information relating to the one or more access points surrounding the electronic device discovered via a search executed by the electronic device is transmitted as a response to the first request on a basis of the first access point not being included in the one or more access points surrounding the electronic device discovered via a search executed by the electronic device.

5. The electronic device according to claim 3, further acting as:
a fourth reception unit configured to receive a second request requesting for information relating to the one or more access points surrounding the electronic device in a state in which a connection between the first access point and the electronic device has been established, and
a second control unit configured to perform control so that information relating to the one or more access points surrounding the electronic device discovered via a search executed by the electronic device is transmitted as a response to the second request,
wherein the first change request is transmitted to the electronic device on a basis of a response to the second request.

6. The electronic device according to claim 1, wherein
the connection destination of the electronic device is changed to the first access point, on a basis of the predetermined amount of time elapsing since the connection destination of the electronic device has changed to the second access point on a basis of reception of the first change request and the electronic device not being in communication with an external information device.

7. The electronic device according to claim 1, further acting as:
a printing unit configured to execute printing,
wherein the connection destination of the electronic device is changed to the first access point, on a basis of the predetermined amount of time elapsing since the connection destination of the electronic device has changed to the second access point on a basis of reception of the first change request and the electronic device not currently executing the printing.

8. The electronic device according to claim 1, further acting as:
a reading unit configured to read a document,
wherein the connection destination of the electronic device is changed to the first access point, on a basis of the predetermined amount of time elapsing since the connection destination of the electronic device has changed to the second access point on a basis of reception of the first change request and the electronic device not currently reading the document.

9. The electronic device according to claim 1, wherein
the connection destination of the electronic device is changed to the first access point, on a basis of the predetermined amount of time elapsing since the connection destination of the electronic device has changed to the second access point on a basis of reception of the first change request and a predetermined amount of time has elapsed in a state in which a user operation on the electronic device has not been performed.

10. The electronic device according to claim 1, wherein
the connection destination of the electronic device is changed to the first access point, on a basis of the predetermined amount of time elapsing since the connection destination of the electronic device has changed to the second access point on a basis of reception of the first change request and the electronic device not currently operating as an access point.

11. The electronic device according to claim 1, wherein
the connection destination of the electronic device is changed to the first access point, on a basis of the predetermined amount of time elapsing since the connection destination of the electronic device has changed to the second access point on a basis of reception of the first change request and a frequency band of the first access point and a frequency band of the second access point being identical.

12. The electronic device according to claim 1, further acting as:
a search unit configured to search for one or more access points surrounding the electronic device on a basis of reception of a predetermined operation by a user on the electronic device,
a display unit configured to display information of the one or more access points surrounding the electronic device discovered via a search executed by the electronic device, and
a reception unit configured to receive from a user a selection operation to select one of the one or more access points surrounding the electronic device discovered via a search executed by the electronic device,
wherein the first access point is an access point selected by the selection operation, and
a connection between the first access point and the electronic device is established on a basis of reception of the selection operation from a user.

13. The electronic device according to claim 1, further acting as:
an information reception unit configured to receive connection information for connecting to an access point from an information processing apparatus external to the electronic device,
wherein the first access point is an access point corresponding to the connection information, and
a connection between the first access point and the electronic device is established on a basis of reception of the connection information.

14. The electronic device according to claim 13, further acting as:
an information transmission unit configured to transmit information of the one or more access points surrounding the electronic device discovered via a search executed by the electronic device to the information processing apparatus,
wherein the access point corresponding to the connection information is an access point included in the one or more access points surrounding the electronic device discovered via a search executed by the electronic device.

15. The electronic device according to claim 1, wherein
changing the connection destination of the electronic device on a basis of reception of the first change request is performed on a basis of a Wi-Fi Agile Multiband function.

16. The electronic device according to claim 1, wherein
the first access point and the second access point correspond to different frequency bands.

17. The electronic device according to claim 1, wherein
a connection between the first access point and the electronic device can be established in a 6 GHz band.

18. The electronic device according to claim 1, further acting as:
an execution unit configured to execute at least one of printing and scanning.

19. A method comprising:
establishing a connection between a first access point and an electronic device;
receiving, from the first access point, a first change request to request change of a connection destination of the electronic device;
changing, on a basis of reception of the first change request, the connection destination of the electronic device to a second access point included in one or more access points corresponding to information included in the first change request; and
changing, on a basis of a predetermined amount of time elapsing since the connection destination of the electronic device has changed to the second access point on a basis of reception of the first change request, the connection destination of the electronic device to the first access point without reception of a second change request to request change of the connection destination of the electronic device from the second access point.

20. A non-transitory computer-readable storage medium that stores one or more programs including instructions, which when executed by one or more processors of an information processing apparatus, cause the information processing apparatus to:
establish a connection between a first access point and an electronic device;
receive, from the first access point, a first change request to request change of a connection destination of the electronic device;
change, on a basis of reception of the first change request, the connection destination of the electronic device to a second access point included in one or more access points corresponding to information included in the first change request; and
change, on a basis of a predetermined amount of time elapsing since the connection destination of the electronic device has changed to the second access point on a basis of reception of the first change request, the connection destination of the electronic device to the first access point without reception of a second change request to request change of the connection destination of the electronic device from the second access point.
